(19) United States
(12) Patent Application Publication
(10) Pub. No.: US 2024/0400816 A1
(43) Pub. Date: Dec. 5, 2024

(54) POLYPROPYLENE-BASED PACKAGING MATERIAL

(71) Applicant: TOYO SEIKAN CO., LTD., Tokyo (JP)

(72) Inventors: Takayuki ISHIHARA, Yokohama-shi, Kanagawa (JP); Yuusuke ITOU, Yokohama-shi, Kanagawa (JP)

(73) Assignee: TOYO SEIKAN CO., LTD., Tokyo (JP)

(21) Appl. No.: 18/689,123

(22) PCT Filed: Sep. 13, 2022
(86) PCT No.: PCT/JP2022/034180

§ 371 Date: Mar. 5, 2024

(30) Foreign Application Priority Data
Sep. 13, 2021 (JP) 2021-148930
Sep. 13, 2021 (JP) 2021-148931

(51) Int. Cl. C08L 53/00; B32B 27/32; C08L 23/06; C08L 23/12

(52) U.S. Cl. CPC C08L 53/00; B32B 27/32; C08L 23/06; C08L 23/12; B32B 2307/7265; B32B 2323/04; B32B 2323/10; B32B 2439/00; C08L 2205/22

(57) ABSTRACT

The disclosure relates to a polypropylene-based packaging material containing an ethylene-propylene block copolymer having a phase dispersion structure in which a resin containing polypropylene as a main component is a matrix and a spindle-shaped polypropylene-based elastomer is a domain, and can provide a packaging material having all of drop impact resistance at a low temperature condition, blocking resistance, slipperiness, and flavor barrier properties.

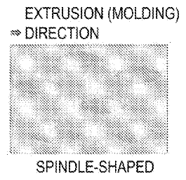

### CROSS REFERENCE TO RELATED APPLICATIONS

This application is a National Stage of International Application No. PCT/JP2022/034180 filed Sep. 13, 2022, claiming priority based on Japanese Patent Application No. 2021-148930 filed Sep. 13, 2021 and Japanese Patent Application No. 2021-148931 filed Sep. 13, 2021.

### TECHNICAL FIELD

The disclosure relates to a polypropylene-based packaging material, and more specifically relates to a polypropylene-based packaging material that has drop impact resistance, blocking resistance, slipperiness, and flavor barrier properties and that can be suitably used for food packaging, and a layered body including a surface layer made of this packaging material.

### BACKGROUND

Packaging materials made of a propylene-based polymer can exhibit heat-sealing properties and have excellent heat resistance, hygiene, and flavor barrier properties, and thus have been widely used as packaging materials for containing various food products. In recent years, from the viewpoints of weight reduction and economical efficiency, packaging containers are made thinner, or drop impact resistance (impact resistance) at low temperatures is required to accommodate use in a cold area and the like, and even higher drop impact resistance is demanded. As a polypropylene having such high drop impact resistance, a propylene block copolymer that is also called an impact polypropylene has been used in a packaging material.

Another performance required for a packaging material is blocking resistance. That is, when films are superimposed, occurrence of blocking needs to be suppressed; however, because films made of the propylene block copolymer contain a soft rubber component, the film has poor blocking resistance, and further modification has been demanded.

To improve these properties, such as drop impact resistance and blocking resistance, for example, JP 2006-161033 A proposes a propylene-based resin composition formed by blending an ethylene/α-olefin copolymer in a propylene block copolymer.

Furthermore, J P 2006-198977 A proposes a multilayered film including a surface layer that uses a polypropylene block copolymer and that is formed by dispersing substantially spherical elastomer particles.

### CITATION LIST

### Patent Literature

Patent Document 1: JP 2006-161033 A
Patent Document 2: JP 2006-198977 A

### SUMMARY

For containers such as trays or cups, container formation, filling of contents, sealing, packaging, and the like are continuously performed while the containers are transported through a conveyor line, transportability that does not cause blockage of the line by the containers, that is, slipperiness, is also required, and excellent slipperiness is required also for a polypropylene-based packaging material. Also, in use for food products, it is particularly important not to impair flavor of contents.

However, for the packaging material using a propylene block copolymer described in JP 2006-161033 A and JP 2006-198977 A, it was difficult to adequately satisfy all of drop impact resistance at a low temperature condition, blocking resistance, and slipperiness. Furthermore, it was difficult to provide a packaging material having these performances as well as appearance characteristics and flavor barrier properties.

An object of the disclosure is to provide a polypropylene-based packaging material having all of drop impact resistance at a low temperature condition, blocking resistance, slipperiness, and flavor barrier properties, and a layered body including this packaging material as a surface layer.

According to the disclosure, a polypropylene-based packaging material is provided. The polypropylene-based packaging material contains an ethylene-propylene block copolymer having a phase dispersion structure in which a resin containing polypropylene as a main component is a matrix, and a spindle-shaped polypropylene-based elastomer is a domain.

The following is preferable for the packaging material of embodiments of the disclosure:
[1] an aspect ratio of the domain is in a range of 1.2 to 9.0;
[2] a minor axis of the domain is in a range of 0.2 to 4.0 μm, and a major axis is in a range of 0.5 to 5.0 μm;
[3] the packaging material contains from 1 to 30 parts by mass of the polypropylene-based elastomer with respect to 100 parts by mass of the resin containing a polypropylene as a main component;
[4] a weight average molecular weight (Mw) of the spindle-shaped polypropylene-based elastomer is from 500000 to 1000000, and a number average molecular weight (Mn) of the spindle-shaped polypropylene-based elastomer is from 10000 to 300000;
[5] a weight average molecular weight (Mw) of the resin containing a polypropylene as a main component is from 300000 to 800000, and a number average molecular weight (Mn) of the resin containing a polypropylene as a main component is from 10000 to 300000;
[6] the packaging material contains from 1 to 30 parts by mass of homopolypropylene with respect to 100 parts by mass of the ethylene-propylene block copolymer;
[7] a plane roughness (Sa) is from 0.15 to 1.0 μm; and
[8] the packaging material has a form of a sheet, a film, a tray, or a cup.

The disclosure also provides a layered body containing a polypropylene layer as a surface layer. The polypropylene layer contains an ethylene-propylene block copolymer that is the polypropylene-based packaging material, and a plane roughness (Sa) of the polypropylene layer is from 0.15 to 1.0 μm.

The following is preferable for the layered body of embodiments of the disclosure:
[1] at least the polypropylene layers are included as inner and outer layers, and an oxygen-absorbing layer and a gas barrier layer are included as intermediate layers; and
[2] the layered body has a form of a tray or a cup.

The disclosure also provides a method for manufacturing a layered body containing a polypropylene layer containing an ethylene-propylene block copolymer as a surface layer. The method includes:
blending and melt-kneading a homopolypropylene as a viscosity modifier in the ethylene-propylene block copolymer to adjust a viscosity to a range where an MFR (230° C., 2.16 kg load) is from 0.1 to 10 g/10 min, and
forming a surface layer having a plane roughness of 0.15 μm to 1.0 μm by extruding the viscosity-adjusted molten resin.

The following is preferable for the method for manufacturing a layered body of embodiments of the disclosure:
[1] from 1 to 30 parts by mass of the homopolypropylene is blended with respect to 100 parts by mass of the ethylene-propylene block copolymer;
[2] the layered body contains from 1 to 30 parts by mass of the polypropylene-based elastomer with respect to 100 parts by mass of the ethylene-propylene block copolymer;
[3] a weight average molecular weight (Mw) of the polypropylene-based elastomer is from 500000 to 1000000, and a number average molecular weight (Mn) of the polypropylene-based elastomer is from 10000 to 300000; and
[4] a weight average molecular weight (Mw) of the resin containing a polypropylene as a main component is from 300000 to 800000, and a number average molecular weight (Mn) of the resin containing a polypropylene as a main component is from 10000 to 300000.

The packaging material according to an embodiment of the disclosure has a dispersion structure in which a resin containing polypropylene as a main component is a matrix and a spindle-shaped polypropylene-based elastomer is a domain, and because the shape and size of the spindle-shaped domain are controlled, excellent drop impact resistance and slipperiness and blocking resistance are provided in a compatible manner.

Furthermore, by using a specific polypropylene-based elastomer, excellent flavor barrier properties can be exhibited.

Furthermore, because the layered body according to an embodiment of the disclosure includes the polypropylene-based packaging material as a surface layer and has a plane roughness (Sa) of the surface layer of 0.15 to 1.0 μm, excellent drop impact resistance and slipperiness and blocking resistance can be provided in a compatible manner. Furthermore, because the layered body according to an embodiment of the disclosure uses a propylene-based polymer having a molecular weight in the range, excellent flavor barrier properties are also achieved.

Furthermore, by the method for manufacturing a layered body according to an embodiment of the disclosure, the viscosity of the ethylene-propylene block copolymer can be adjusted to a viscosity suitable for molding by blending of the homopolypropylene, and moldability (workability) can be improved without impairing drop impact resistance of the layered body.

### BRIEF DESCRIPTION OF DRAWINGS

The FIGURE is a drawing to explain a domain shape in a packaging material according to an embodiment of the disclosure.

### DESCRIPTION OF EMBODIMENTS

### Polypropylene-Based Packaging Material

As described above, an important characteristic of the packaging material according to an embodiment of the disclosure is having a phase dispersion structure in which a resin containing a polypropylene as a main component is a matrix and a spindle-shaped polypropylene-based elastomer is a domain.

In an embodiment of the disclosure, because the spindle-shaped domains made of the polypropylene-based elastomer are dispersed in the matrix made of the resin containing a polypropylene as a main component, drop impact resistance is further improved, and because the dispersion particle size of the domain made of this rubber component is controlled, slipperiness and blocking resistance can be provided in a compatible manner in addition to the drop impact resistance.

That is, to exhibit excellent drop impact resistance even at a low temperature for a packaging material using a propylene block copolymer, the content of the rubber component (polypropylene-based elastomer) is preferably large, and the domains (dispersion particles) made of this rubber component are preferably finely dispersed from the perspective of appearance characteristics in addition to the drop impact resistance. On the other hand, to improve the blocking resistance and the slipperiness, the content of the rubber component is preferably small, and the dispersion particles made of this rubber component are preferably of a sufficient size to have protrusions and recesses formed on the surface.

In an embodiment of the disclosure, from these perspectives, it was found that excellent drop impact resistance and blocking resistance and slipperiness can be provided in a compatible manner due to the dispersion structure in which the spindle-shaped domains made of the polypropylene-based elastomer are formed in the matrix made of the resin containing a polypropylene as a main component.

In an embodiment of the disclosure, to exhibit excellent drop impact resistance by the domain made of the polypropylene-based elastomer, the domain preferably has a spindle shape having an aspect ratio of the spindle-shaped domain of preferably in a range of 1.2 to 9.0, 1.2 to 8.0, 1.9 to 8.0, and particularly 1.9 to 5.0. When the aspect ratio is large, the slipperiness tends to be poor although the drop impact resistance is good. The domain also preferably has a minor axis in a range of 0.2 to 4.0 μm, and particularly 0.2 to 2.0 μm, and a major axis in a range of 0.5 to 5.0 μm, and particularly 0.5 to 3.0 μm. Note that the measurement method for the minor axis and the major axis of the domain will be described below.

Furthermore, the domain size corresponding to a circle is preferably in a range of 0.5 μm to 5.0 μm, and particularly 0.5 μm to 1.0 μm. When the domain size is too small, the slipperiness is poor because protrusions and recesses of the surface are not formed. When the domain size is too large, the drop impact resistance tends to be poor although the slipperiness is good because the protrusions and recesses are formed.

Control of the domain shape and size described above is decided based on the molecular weights and compositions of the resin containing a polypropylene as a main component, which is the matrix, and the polypropylene-based elastomer, and the resin manufacturing method such as kneading.

In the packaging material of an embodiment of the disclosure, the polypropylene-based elastomer is preferably contained in an amount of 1 to 30 parts by mass, and particularly 5.0 to 25 parts by mass, with respect to 100 parts by mass of the resin containing a polypropylene as a main component. When the amount of the polypropylene-based elastomer is less than the range described above, the drop impact resistance may not be adequately improved compared to the case where the amount is in the range described above. On the other hand, when the amount of the polypropylene-based elastomer is greater than the range described above, in addition to deterioration in the blocking resistance and the slipperiness, the flavor barrier properties deteriorate, and the appearance characteristics become poor because the surface protrusions and recesses become greater compared to the case where the amount is in the range described above.

### Resin Containing Polypropylene as Main Component

In the packaging material of an embodiment of the disclosure, the resin containing a polypropylene as a main component, which is the matrix, is a homo or random polypropylene obtained by polymerizing a monomer mainly containing propylene.

The resin containing a polypropylene as a main component preferably has the weight average molecular weight (Mw) in a range of 300000 to 800000, and particularly 300000 to 600000 and the number average molecular weight (Mn) in a range of 10000 to 300000, and particularly 50000 to 200000. When the molecular weight of the resin containing a polypropylene as a main component is less than the range described above, the drop impact resistance may deteriorate or hygiene may deteriorate compared to the case where the molecular weight is in the range described above. On the other hand, when the molecular weight is greater than the range described above, moldability may deteriorate due to abnormal resin pressure compared to the case where the molecular weight is in the range described above.

Furthermore, from the perspective of heat resistance and moldability, the resin containing a polypropylene as a main component preferably has a mesopentad fraction ([mmmm]), which is an indicator for tacticity, in a range of 95 to 99.

### Polypropylene-Based Elastomer

In the packaging material of an embodiment of the disclosure, examples of the polypropylene-based elastomer constituting the spindle-shaped domain include a propylene-ethylene-based elastomer. As the propylene-ethylene-based elastomer, a copolymer that is a random copolymer of propylene and ethylene and that has a mass ratio of an ethylene unit to a propylene unit in a range of 15:85 to 50:50 is preferred. Furthermore, as necessary, an elastomer obtained by copolymerizing α-olefin and the like may be used to improve miscibility and drop impact resistance.

The weight average molecular weight (Mw) of the polypropylene-based elastomer is in a range of 500000 to 1000000, preferably in a range of 650000 to 1000000, even more preferably in a range of 700000 to 1000000, and particularly preferably in a range of 700000 to 900000. The number average molecular weight (Mn) of the polypropylene-based elastomer is in a range of 10000 to 300000, preferably in a range of 20000 to 200000, and particularly preferably in a range of 100000 to 200000. When the molecular weight is less than the range described above, the domain shape becomes a streak shape and has a small particle size, thus the domains are finely dispersed, the surface protrusions and recesses of the container become smoother, and thus the blocking resistance and the slipperiness may not be satisfied compared to the case where the molecular weight is in the range described above. On the other hand, when the molecular weight is greater than the range described above, the domain shape becomes substantially spherical and has a large particle size, the domains are thus sparsely dispersed, and thus the drop impact resistance may be poor. Furthermore, the flavor barrier properties tend to deteriorate.

Thus, by controlling the mass ratio of the ethylene unit to the propylene unit of the polypropylene-based elastomer and the molecular weight, and the molecular weight of the resin containing a polypropylene as a main component, the domain of the polypropylene-based elastomer can be stretched into a spindle shape having the aspect ratio described above, the miscibility of these is improved, fine dispersion in the size described above can be formed, and thus the drop impact resistance and the blocking resistance and slipperiness can be provided in a compatible manner.

Regarding the polypropylene-based elastomer of an embodiment of the disclosure having a spindle shape, the following is presumed. For a produced film or sheet or a container, such as a cup or a tray, obtained by secondary processing, the resin is stretched in a direction of extrusion (molding). Thus, the domain shape in the resin also follows this, and the tip in the extrusion direction becomes tapered and thus becomes a spindle shape illustrated in the FIGURE. However, it is conceived that the domain shape varies depending on the molecular weight difference between the matrix and the domain, the molecular weight of the domain itself, and the miscibility between the matrix and the domain. For example, in a case where the molecular weight of the domain is small, and the miscibility with the matrix is high, the domain shape becomes a streak shape, the plane roughness becomes low and the surface becomes smooth, and thus it is presumable that the slipperiness is poor. On the other hand, when the molecular weight of the domain is high and the miscibility with the matrix is low, the domain becomes substantially spherical, and it is presumable that the drop impact resistance is poor. Note that the miscibility is affected by the composition of the polypropylene-based elastomer and addition of an ethylene/α-olefin copolymer and the like.

### Ethylene-Propylene Block Copolymer

The MFR (230° C., 2.16 kg load) of the ethylene-propylene block copolymer having a phase dispersion structure, in which the resin containing a polypropylene as a main component is the matrix and the spindle-shaped polypropylene-based elastomer is the domain, is preferably in a range of 0.1 to 10 g/10 min, and particularly 0.2 to 5 g/10 min, from the perspective of molding.

Furthermore, the raw material or a part of the raw material of the resin containing a polypropylene as a main component and/or the polypropylene-based elastomer may be an ethylene-propylene block copolymer produced, not only from a raw material derived from petroleum, but also from a raw material obtained by chemical recycling of waste plastic through a monomerization technology, such as gasification or liquefaction, or from a biomass material derived from a plant. The biomass content can be measured by radiocarbon concentration measurement or the like. Furthermore, when the resin containing a polypropylene as a main component or the polypropylene-based elastomer is produced, production is preferably performed by a catalyst system using no SVHC substances (Substance of Very High Concern in Registration, Evaluation, Authorization and Restriction of Chemicals (REACH) regulation in Europe) such as a phthalate compound from the perspective of reducing environmental load in the polymerizing of raw materials.

### Other Components

In the packaging material of an embodiment of the disclosure, in addition to the ethylene-propylene block copolymer described above, a homopolypropylene is preferably blended as a viscosity modifier.

That is, because the resin composition made of the resin containing a polypropylene as a main component and the polypropylene-based elastomer tends to have a higher molecular weight of the polypropylene-based elastomer to provide the drop impact resistance and the slipperiness in a compatible manner, has a high viscosity, and may have poor moldability, the viscosity can be adjusted by blending a homopolypropylene, extrudability of the molten resin can be improved, and thus moldability (workability) can be improved without impairing the drop impact resistance of the packaging material.

From the perspective of viscosity adjustment, the MFR (230° C., 2.16 kg load) of the homopolypropylene is preferably in a range of 0.5 to 20 g/10 min.

The homopolypropylene is preferably added in an amount of 1 to 40 parts by mass, and particularly preferably 1 to 30 parts by mass, with respect to 100 parts by mass of the ethylene-propylene block copolymer.

Furthermore, in the packaging material of an embodiment of the disclosure, to further improve the drop impact resistance, an ethylene/α-olefin copolymer such as high density polyethylene, medium density polyethylene, low density polyethylene, or linear low density polyethylene, and/or a rubber component such as an elastomer or a plastomers may be added. Furthermore, addition of a lubricant such as calcium stearate to improve the slipperiness, addition of an anti-blocking agent such as silica particles, and a combined use with the rubber component described above are also possible. A known additive, such as an antioxidant can be blended in a small amount as necessary.

As a part of plastic reduction due to growing interest in environmental issues in recent years, it is important to blend a raw material obtained by chemical recycling of waste plastic through a monomerization technology, such as gasification or liquefaction, or a biomass material derived from a plant.

### Preparation of Polypropylene-Based Packaging Material

The packaging material of an embodiment of the disclosure can be prepared by a known method, such as a method of melt-extruding and a method of melt-kneading pellets of these in a kneader.

In an embodiment of the disclosure, melt-kneading needs to be performed in a manner that the domains of the polypropylene-based elastomer are dispersed and each have the size and the spindle shape having the aspect ratio described above, the kneading conditions need to be appropriately adjusted based on the viscosity of the resin to be used and the like.

The temperature conditions of the melt kneading are not particularly limited but the melt kneading is preferably performed in a range of 170 to 270° C. When the temperature is lower than the range described above, the kneading may not be efficiently performed. When the temperature is higher than the range described above, deterioration of the resin may occur.

The packaging material of an embodiment of the disclosure can be formed into a desired shape such as a film, a sheet, or a tube by subjecting the melt-kneaded resin to a known manufacturing method such as extrusion molding or injection molding, or the obtained sheet can be subjected to thermoforming to form a shape such as a cup or a tray.

The packaging material of an embodiment of the disclosure preferably has the plane roughness (Sa) in a range of 0.15 to 1.0 μm. As a result, excellent blocking resistance and slipperiness can be exhibited without impairing appearance characteristics. Note that the plane roughness (Sa) is the extension of arithmetical mean height of a line (Ra) to a surface and is, as stipulated in ISO 25178, an average of absolute values of the differences in height of respective points compared to the arithmetical mean of the surface.

### Layered Body

An embodiment of the disclosure may be a molded body having a single layered structure of a resin composition made of the ethylene-propylene block copolymer described above and may be a layered body having a multilayered structure including other layer(s).

In a case of such a multilayered structure, the polypropylene layer made of the resin composition of the ethylene-propylene block copolymer described above is preferably a surface layer (outermost layer or innermost layer) and is particularly preferably an outermost layer. That is, because the surface layer of the layered body has a dispersion structure in which the spindle-shaped domains made of the polypropylene-based elastomer are dispersed in the matrix made of the resin containing a polypropylene as a main component, the drop impact resistance is further improved, and excellent drop impact resistance can be exhibited also at a low temperature. In addition, because the plane roughness is in the range described above, excellent slipperiness and blocking resistance can be exhibited.

### Multilayered Structure

In the layered body of an embodiment of the disclosure, it is important that the polypropylene layer is a surface layer (outermost layer or innermost layer), and the polypropylene layer is at least an outermost layer, and preferably both of an outermost layer and an innermost layer. As long as the surface layer is made of the polypropylene layer, various multilayered structures can be employed, and known other layer(s) are preferably included as intermediate layer(s), such as a gas barrier layer, an oxygen-absorbing layer, an adhesive layer, a regrind layer, and an adsorbent-containing layer.

The layered body of an embodiment of the disclosure is not limited to these, and examples of the layer structure include the following:

polypropylene layer (outermost layer)/adhesive layer/gas barrier layer/adhesive layer/polypropylene surface layer (innermost layer), polypropylene layer (outermost layer)/adhesive layer/gas barrier layer/adhesive layer/oxygen-absorbing layer/polypropylene layer (innermost layer), polypropylene layer (outermost layer)/adhesive layer/gas barrier layer/adhesive layer/oxygen-absorbing layer/adhesive layer/gas barrier layer/adhesive layer/polypropylene layer (innermost layer), polypropylene layer (outermost layer)/regrind layer/adhesive layer/gas barrier layer/adhesive layer/oxygen-absorbing layer/polypropylene layer (innermost layer), polypropylene layer (outermost layer)/regrind layer/adhesive layer/gas barrier layer/adhesive layer/polypropylene surface layer (innermost layer), and polypropylene layer (outermost layer)/regrind layer/adhesive layer/gas barrier layer/oxygen-absorbing layer containing a gas barrier resin as a matrix resin/gas barrier layer/adhesive layer/adsorbent-containing layer/polypropylene layer (innermost layer).

Note that the innermost layer may be a layer made of an easily releasable resin in place of or in addition to the polypropylene layer described above.

In the layered body of an embodiment of the disclosure, the layer thickness of each layer varies depending on the form of the layered body, manufacturing method, and the like and cannot be unconditionally provided; however, in a case of a film or a sheet, the thickness of the polypropylene surface layer (outermost layer) is in a range of 5 to 800 μm, and particularly preferably 5 to 500 μm, and the thickness of the polypropylene surface layer (innermost layer) is in a range of 5 to 800 μm, and particularly preferably 5 to 500 μm. Also, as the thickness of another layer, in a case where the outermost layer and the innermost layer have thicknesses in the ranges described above, the thickness of the gas barrier layer (in a case where multiple gas barrier layers are formed, total thickness) is in a range of 5 to 500 μm, and particularly preferably 5 to 200 μm, and the thickness of the oxygen-absorbing layer is in a range of 5 to 500 μm, and particularly preferably 5 to 200 μm. Furthermore, in a case where a regrind layer is provided, the regrind layer is preferably formed in a manner that the thickness thereof is in a range of 50 to 1000 μm, and particularly 50 to 800 μm. Furthermore, in a case where an adsorbent-containing layer is provided, the adsorbent-containing layer is preferably formed in a manner that the thickness thereof is in a range of 5 to 500 μm, and particularly preferably 5 to 300 μm.

Furthermore, in a case where the layered body of an embodiment of the disclosure is a multilayered container (cup, tray, or the like) formed by thermoforming such as pressure forming, in a middle part which is the part having the smallest thickness of the multilayered container, the thickness of the polypropylene surface layer (outermost layer) is in a range of 1 to 160 μm, and particularly preferably 1 to 100 μm, and the thickness of the polypropylene surface layer (innermost layer) is in a range of 1 to 160 μm, and particularly preferably 1 to 100 μm. Also, as the thickness of another layer, in a case where the outermost layer and the innermost layer have thicknesses in the ranges described above, the thickness of the gas barrier layer (in a case where multiple gas barrier layers are formed, total thickness) is in a range of 1 to 100 μm, and particularly preferably 1 to 40 μm, and the thickness of the oxygen-absorbing layer is in a range of 1 to 100 μm, and particularly preferably 1 to 40 μm. Furthermore, in a case where a regrind layer is provided, the regrind layer is preferably formed in a manner that the thickness thereof is in a range of 10 to 200 μm, and particularly 10 to 160 μm. Furthermore, in a case where an adsorbent-containing layer is provided, the adsorbent-containing layer is preferably formed in a manner that the thickness thereof is in a range of 1 to 100 μm, and particularly preferably 1 to 60 μm.

By this, effects of each layer, such as gas barrier properties, oxygen absorbing properties, or flavor barrier properties, can be adequately exhibited without impairing the drop impact resistance or the moldability.

### Gas Barrier Layer

The gas barrier layer of the layered body in an embodiment of the disclosure can use a known barrier resin but is particularly preferably made of an ethylene-vinyl alcohol copolymer. For example, the ethylene-vinyl alcohol copolymer is preferably a saponified product of copolymer obtained by saponifying an ethylene-vinyl acetate copolymer having an ethylene content of 20 to 60 mol %, and particularly 25 to 50 mol %, in a manner that degree of saponification becomes 96% or greater, and particularly 99 mol % or greater, from the perspective of the gas barrier properties; however, in an embodiment of the disclosure, an ethylene-vinyl alcohol copolymer having an ethylene content of 20 to 35 mol % and an ethylene-vinyl alcohol copolymer having an ethylene content of 36 to 50 mol % that are blended in a blending ratio (mass ratio) of 90:10 to 50:50, and particularly 80:20 to 60:40, are particularly preferably used. By this, moldability is improved while gas barrier layer of the gas barrier layer maintains excellent gas barrier properties, and thus a layered body without uneven appearance can be formed.

This ethylene-vinyl alcohol copolymer should have a molecular weight that is adequate for forming a film and, in general, preferably has an intrinsic viscosity measured at 30° C. of 0.01 dL/g or greater, and particularly 0.05 dL/g or greater, in a mixed solvent having a mass ratio of [phenol/water] of 85/15.

Furthermore, examples of the gas barrier resin besides the ethylene-vinyl alcohol copolymer include a polyamide such as nylon 6, nylon 6,6, a nylon 6/6,6 copolymer, m-xylylene diadipamide (MXD6), nylon 6,10, nylon 11, nylon 12, and nylon 13. Among these polyamides, a polyamide having the number of amide groups in a range of 5 to 50, and particularly 6 to 20, per 100 carbons is preferred. The polyamide should have a molecular weight adequate for forming a film and, for example, preferably has a relative viscosity measured at 30° C. of 1.1 or greater, and particularly 1.5 or greater, in a concentrated sulfuric acid (concentration: 1.0 g/dL).

Note that the polyamide may be blended in the ethylene-vinyl alcohol copolymer, and the blending ratio (mass ratio) of the ethylene-vinyl alcohol copolymer to the polyamide is preferably 50:50 to 99:1.

Furthermore, in a case where the polyamide is used as the matrix resin in an oxygen-absorbing resin composition as described below, a polyamide resin having a terminal amino group concentration of 40 eq/10⁶ g or greater is preferred because oxidation degradation does not occur during oxygen absorption.

### Oxygen-Absorbing Layer

The oxygen-absorbing layer in the layered body of an embodiment of the disclosure can be made of a resin composition obtained by using a propylene-based polymer constituting the polypropylene layer described above or a known propylene-based polymer (hereinafter, these are collectively, simply referred to as “propylene-based polymer”), a gas barrier resin, a regrind resin, or the like as a matrix resin; and blending an inorganic oxygen-absorbing agent or an organic oxygen-absorbing agent containing (i) an oxidation organic component and (ii) a transition metal catalyst (oxidation catalyst) in the matrix resin.

### Inorganic Oxygen-Absorbing Agent

Examples of the inorganic oxygen-absorbing agent include iron powder, titanium oxide, cerium oxide, iron (II) salt, dithionite, sulfite, metal halide, and zeolite. In particular, iron powder and metal halide are preferred. As the iron powder, a known iron powder such as reduced iron powder, atomized iron powder, electrolytic iron powder, carbonyl iron powder can be used. Among these, reduced iron powder that is porous and that has a relatively large specific surface area, particularly rotary reduced iron powder, can be preferably used. The rotary reduced iron powder has a high purity and a large specific surface area, and thus has excellent oxygen-absorbing performance. One type or a combination of two or more types of these iron powders may be used. The content of the iron powder in the oxygen-absorbing agent is preferably from 3 to 40 parts by mass, and more preferably from 5 to 30 parts by mass, with respect to 100 parts by mass of the oxygen-absorbing agent.

Examples of the metal halide include halide of alkali metal, alkaline-earth metal, copper, zinc, and iron. Specific examples thereof include sodium chloride, sodium bromide, sodium iodide, potassium chloride, potassium bromide, potassium iodide, calcium chloride, magnesium chloride, and barium chloride. Among these, sodium chloride is preferred. One type or a combination of two or more types of these metal halides may be used.

The metal halide is blended in an amount of preferably 0.1 to 10 parts by mass, and more preferably 1 to 5 parts by mass, with respect to 100 parts by mass of the iron powder which is the main agent of the oxygen-absorbing agent. By blending 0.1 parts by mass or greater of the metal halide with respect to 100 parts by mass of the iron powder, adequate oxygen-absorbing performance can be achieved. Furthermore, by blending 10 parts by mass or less of the metal halide with respect to 100 parts by mass of the iron powder, deterioration of the oxygen-absorbing performance due to reduction in the iron powder content can be suppressed, and appearance failure due to leaking of the metal halide and attachment of the metal halide to contents can be suppressed.

The oxygen-absorbing agent according to an embodiment of the disclosure may further contain an alkaline substance in addition to the iron powder and the metal halide. By allowing the alkaline substance to be contained, the amount of generation of hydrogen generated due to a reaction between iron and water can be reduced. Examples of the alkaline substance include magnesium hydroxide, calcium hydroxide, strontium hydroxide, barium hydroxide, magnesium carbonate, calcium carbonate, strontium carbonate, and barium carbonate. Among these, calcium hydroxide and calcium oxide that is a dehydration product of calcium hydroxide are preferred. One type or a combination of two or more types of these alkaline substances may be used.

### Organic Oxygen-Absorbing Agent

### (i) Oxidation Organic Component

Examples of the oxidation organic component include an ethylene-based unsaturated group-containing polymer. This polymer contains a carbon-carbon double bond, and this double bond portion and, in particular, α-methylene adjacent to the double bond portion are easily oxidized by oxygen, and due to this, oxygen is captured.

For example, such an ethylene-based unsaturated group-containing polymer, such as a homopolymer of a polyene derived using a polyene as a monomer, or a random copolymer or block copolymer of a combination of two or more types of the polyenes or a combination with another monomer, can be used as the oxidation polymer.

Among the polymers derived from polyenes, for example, polybutadiene (BR), polyisoprene (IR), natural rubber, nitrile-butadiene rubber (NBR), styrene-butadiene rubber (SBR), chloroprene rubber, and ethylene-propylene-diene rubber (EPDM) are preferred but, needless to say, not limited to these.

Furthermore, besides the ethylene-based unsaturated group-containing polymer described above, a polymer that is easily oxidized, such as polypropylene, an ethylene/propylene copolymer, or poly(m-xylylene diadipamide) having a terminal amino group concentration of less than 40 eq/106 g can be used as the oxidation organic component.

Note that, from the perspective of moldability and the like, the viscosity at 40° C. of the oxidation polymer or a copolymer thereof is preferably in a range of 1 to 200 Pa·s.

These polyene-based polymers are preferably acid-modified polyene polymers in which a carboxylic acid group, a carboxylic anhydride group, or a hydroxy group is introduced.

The oxidation organic component made of the oxidation polymer or a copolymer thereof is preferably contained in a proportion of 0.01 to 10 mass % in the oxygen-absorbing resin.

### (ii) Transition Metal Catalyst

As the transition metal catalyst, Group 8 metals in the periodic table such as iron, cobalt, and nickel are preferred. In addition, the transition metal catalyst may be Group 1 metals such as copper and silver, Group 4 metals such as tin, titanium, and zirconium, Group 5 metals such as vanadium, Group 6 metals such as chromium, or Group 7 metals such as manganese.

The transition metal catalyst is typically used in a form of an inorganic salt of the transition metal described above with a low valency, an organic salt, or a complex salt. Examples of the inorganic salt include a halide such as chloride, an oxysalt of sulfur such as sulfate, an oxyacid salt of nitrogen such as nitrate, an oxysalt of phosphorus such as phosphate, and silicate. Examples of the organic salt include carboxylate, sulfonate, and phosphonate. Furthermore, examples of the complex of transition metal include a complex with β-diketone or β-keto acid salt.

The transition metal catalyst preferably has a concentration (based on mass concentration) of transition metal atoms in a range of 100 to 3000 ppm in the oxygen-absorbing resin.

### Adhesive Layer

In the layered body of an embodiment of the disclosure, as necessary, an adhesive layer can be formed in between layers. In particular, in a case where the gas barrier layer is made of an ethylene-vinyl alcohol copolymer, because adhesion to the polypropylene layer forming the inner and outer layers is poor, an adhesive layer is preferably interposed.

Examples of the adhesive resin used in the adhesive layer include a thermoplastic resin containing a carbonyl (—CO—) group, originated from carboxylic acid, carboxylic anhydride, carboxylic acid salt, carboxylic amide, or carboxylic acid ester, in a main chain or a side chain in a concentration of 1 to 700 milliequivalent (meq)/100 g resin, and particularly 10 to 500 (meq)/100 g resin.

Suitable examples of the adhesive resin include a material made of a blended product of a maleic anhydride-modified olefin resin with an ethylene-acrylic acid copolymer, an ionically crosslinked olefin copolymer, a maleic anhydride graft polyethylene, a maleic anhydride-modified polypropylene, a maleic anhydride graft polypropylene, an acrylic acid graft polyolefin, an ethylene-vinyl acetate copolymer, or an ethylene-vinyl alcohol copolymer. In particular, a maleic anhydride-modified polypropylene and a maleic anhydride graft polypropylene can be suitably used. One type or a combination of two or more types of the adhesive resins can be used, or the adhesive resin may be blended in a polyolefin-based resin.

### Adsorbent-Containing Layer

In the layered body of an embodiment of the disclosure, the adsorbent-containing layer formed as necessary is preferably positioned on an inner layer side compared to the oxygen-absorbing layer. By this, transition of byproducts generated by oxygen absorption reaction into the container is suppressed, and the flavor barrier properties for contents can be improved.

The adsorbent is preferably blended in the propylene-based polymer or the regrind resin described above.

As the adsorbent, a known adsorbent can be used, and a porous inorganic substance containing silicate as a main component, such as zeolite or powder of activated clay obtained by subjecting smectite clay mineral such as montmorillonite to an acid treatment, is preferred. In particular, high-silica zeolite (silica/alumina ratio is 100 or greater) which is an Na-type ZSM-5 zeolite is preferred because the high-silica zeolite has excellent functions to capture odor that is characteristic of plastics and functions to capture oxidation decomposition products described above.

In general, such an adsorbent is preferably blended in an amount of 0.5 to 10 mass % in the adsorbent-containing layer.

### Easily Releasable Layer

In the layered body of an embodiment of the disclosure, for example, in a case where the layered body of an embodiment of the disclosure is a tray or a cup with a flange obtained by subjecting a multilayered sheet to thermoforming, the innermost layer of the layered body is preferably an easily releasable layer (easily unscalable layer). That is, in such a tray or a cup, when a top face of the flange part to which a lid member is attached is an easily releasable layer, unsealability of the lid is remarkably improved.

As such an easily releasable layer, for example, the easily unscalable layer is preferably made of a blended material of a propylene-based polymer and an ethylene-based polymer for a lid member, in which at least an attaching face with a flange part is made of a propylene-based polymer or an ethylene-based polymer.

Examples of the propylene-based polymer include, besides the homopolypropylene, a random copolymer of propylene and ethylene or another α-olefin, such as 1-butene, 1-pentene, 1-hexene, 4-methyl-1-pentene, or 1-octene. Furthermore, examples of the ethylene-based polymer include homopolymers of ethylene such as low density polyethylene (LDPE), linear low density polyethylene (LLDPE), and medium/high density polyethylene (MDPE, HDPE), a copolymer or ionomer of ethylene and another α-olefin, such as 1-butene, 1-pentene, 1-hexene, 4-methyl-1-pentene, or 1-octene, and/or a vinyl-based monomer, such as (meth)acrylic acid, (meth)acrylate, methyl (meth)acrylate, vinyl acetate, or styrene.

### Method for Manufacturing Layered Body

In the method for manufacturing a layered body of an embodiment of the disclosure, by blending and melt-kneading a homopolypropylene as a viscosity modifier in the ethylene-propylene block copolymer, and by extruding the molten resin in which a viscosity is adjusted to a range where an MFR (230° C., 2.16 kg load) is from 0.2 to 5 g/10 min, a layered body including a surface layer having a plane roughness (Sa) of 0.15 to 1.0 μm, and particularly 0.15 to 0.80 μm, is formed.

As described above, by allowing the homopolypropylene to be blended in an amount of 1 to 40 parts by mass, and particularly preferably 1 to 30 parts by mass, with respect to 100 parts by mass of the ethylene-propylene block copolymer, the viscosity of the resin composition can be adjusted to the range described above without impairing excellent performances of the layered body of an embodiment of the disclosure, such as the drop impact resistance, the blocking resistance, the slipperiness, and the like, the moldability (workability) can be improved, and the plane roughness (Sa) of the polypropylene layer can be adjusted to the range described above. That is, in a case where the MFR of the resin composition is less than the range described above, a target layered body may not be obtained because film formation cannot be performed due to resin pressure abnormality, or the plane roughness (Sa) may not be adjusted to the range described above due to occurrence of wave caused by unstable flow. Furthermore, when the MFR is higher than the range described above, smoothness of the surface layer tends to be high, and it becomes difficult to adjust the plane roughness (Sa) to the range described above.

The melt-kneading of the ethylene-propylene block copolymer and the homopolypropylene can be performed by, after pellets of these are dry-blended by a mixer or the like, a known method such as a method of melt-extruding or a method of melt-kneading pellets of these in a kneader.

In an embodiment of the disclosure, melt-kneading needs to be performed in a manner that the domains of the polypropylene-based elastomer are dispersed and have a spindle shape having the size described above, the kneading conditions need to be appropriately adjusted based on the viscosity of the resin to be used and the like.

The temperature conditions of the melt kneading are not particularly limited but the melt kneading is preferably performed in a range of 170 to 270° C. When the temperature is lower than the range described above, the kneading may not be efficiently performed. When the temperature is higher than the range described above, deterioration of the resin may occur.

The layered body of an embodiment of the disclosure can be manufactured by a known method except for using the molten resin (blended material) in which the MFR has been adjusted as described above; however, although the method is not limited to this, the layered body may be layered with another layer by a coextrusion method, a coinjection method, or an extrusion lamination method, or may be layered with another layer by preparing in advance a single layered film or sheet using the blended material by extrusion molding and then layered with such another layer by a dry lamination method, and by this, the layered body can be formed into a shape such as a multilayered film, a multilayered sheet, or a multilayered tube. Furthermore, by thermoforming of the multilayered sheet, formation into a cup or a tray can be performed.

In the method for manufacturing the layered body of an embodiment of the disclosure, as various resins or resin compositions constituting the intermediate layer described above constituting the layered body, a material having a thermal shrinkage similar to that of the resin composition (blended material) constituting the polypropylene layer is preferably used. For example, by using the resin composition (blended material) constituting the polypropylene layer as the matrix of the oxygen-absorbing resin layer, it becomes possible to suppress irregular winding caused by a difference in shrinkages of formed layered sheets and to suppress occurrence of formation failure.

Furthermore, according to the manufacturing method of an embodiment of the disclosure, because the layered body having a polypropylene surface layer having a plane roughness (Sa) in a range of 0.15 to 1.0 μm can be formed, the slipperiness is improved, thus blockage of a line by containers does not occur even when formation process, filling and scaling process, packaging process, and the like are continuously performed on a conveyor line, and excellent productivity can be exhibited.

Examples of such another layer include, but are not limited to, a known layer used for a known polypropylene-based multilayered packaging material, such as a gas barrier layer, an oxygen-absorbing layer, a regrind layer, an easily releasable layer, and an adhesive layer.

Note that, in a case where the multilayered structure is employed, the resin or resin composition constituting the other layer preferably has a thermal shrinkage similar to that of the ethylene-propylene block copolymer, and by this, irregular winding caused by a difference in shrinkages of layered sheets can be suppressed, and occurrence of formation failure can be suppressed.

### EXAMPLE

The disclosure will be further described with experimental examples, but the disclosure is not limited to these.

### Experimental Examples 1 to 5

Using a 6-kind 7-layer sheet forming device, resins were melt-kneaded by a single-screw extruder, extruded into a sheet shape from a T-die at a T-die temperature of 230° C., and then brought into contact with a cooling roll to solidify. The solidified sheet was wound, and thus a multilayered sheet having a thickness of 500 μm was formed. The layer structure was, from the outer side, outermost PP layer/regrind layer/adhesive layer/barrier layer/adhesive layer/oxygen scavenger layer/inner PP layer/easily releasable adhesive layer.

For the outermost PP layer and the inner PP layer, a resin containing a polypropylene as a main component and pellets of an ethylene-propylene block copolymer made of a polypropylene-based elastomer, which had compositions and molecular weights listed in Table 1, and a resin for white color were used. As the regrind layer, a material obtained by blending 44 parts by mass of the ethylene-propylene block copolymer listed in Table 1 with respect to 100 parts by mass of a part of multilayered sheet and trimmed part generated during the present test and scraps obtained by crushing sheet skeleton, and then adding a compatibilizing agent and a resin for white color was used. For the adhesive layer, maleic anhydride-modified polypropylene was used. For the oxygen scavenger layer, a resin composition obtained by kneading 29 parts by mass of iron-based oxygen-absorbing agent (mixture of 100 parts by mass of reduced iron powder, 2 parts by mass of sodium chloride, and 1 part by mass of calcium hydroxide) and 71 parts by mass of random polypropylene having an MFR of 0.6 g/10 min was used. The easily releasable adhesive layer was a resin obtained by dry-blending polypropylene and polyethylene.

Furthermore, the obtained multilayered sheet was heated at 145° C. and subjected to plug assist vacuum pressure molding, and thus a multilayered tray having a flange was formed.

Note that the container dimension was as follows: a flange external diameter was 155 mm major axis×120 mm minor axis, a bore size was 135 mm major axis×100 mm minor axis, a bottom part external diameter was 115 mm major axis×90 mm minor axis, and a height was 35 mm.

### Experimental Example 6

A multilayered tray was formed in the same manner as in Experimental Example 1 except for using a resin obtained by dry-blending 17.7 parts by mass of a homopolypropylene having an MFR of 2.0 g/10 min (230° C., 2.16 kg load) in 100 parts by mass of the resin for each of the outermost PP layer and the inner PP layer.

The measurement methods were as follows.

### Structural Analysis of Ethylene-Propylene Block Copolymer

For the ethylene-propylene block copolymers used in Experimental Examples 1 to 5, blending ratio of the resin containing a polypropylene as a main component (PP component) and the polypropylene-based elastomer (rubber component) and molecular weights were determined by ¹³C-NMR (available from JEOL Ltd.) and GPC (available from Agilent). As the pretreatment of the measurement sample, the resin was subjected to xylene reflux and dissolution and, after radiational cooling, subjected to solid-liquid separation. The xylene-soluble fraction was reprecipitated with methanol, the precipitate was taken out by filtration, and dried. The mass thereof was measured and used as a rubber component amount. The xylene-insoluble fraction was dissolved again and reprecipitated with methanol, then filtered, and dried. The dried resin was used as a PP component. For Experimental Example 6, because the homopolypropylene was dry-blended, a calculated value was used.

### (1) Dispersion State (Domain Shape and Size)

A cross-section obtained by cutting the bottom part of the obtained multilayered tray parallel to a winding direction in the sheet production was observed by using a transmission electron microscope (TEM; available from Hitachi, Ltd.). As the pretreatment, a sample cut out from the multilayered tray was adhered to a Cryo supporting platform and subjected to cutting using an ultramicrotome (available from Leica) equipped with a diamond knife by CryoSystem (available from Leica). Then, vapor dying by metal oxide was performed, and thus an ultrathin section was prepared.

Based on the obtained TEM image (20 μm×20 μm square), all domains of the polypropylene-based elastomer of the outermost PP layer in the multilayered tray were measured by using an image analysis-type particle size distribution analysis software (Mac-View, available from Mountech Co., Ltd.), and thus measurement of each minor axis and major axis and calculation of an aspect ratio and a domain size corresponding to a circle were performed. An average value was determined based on the measurement results of all domains.

### (2) Plane Roughness Sa (Unit: μm)

A 10 mm×10 mm sample piece was cut out from the bottom part of the obtained multilayered tray. By using a non-contact surface measurement device (available from Zygo Corporation), shape measurement of the outer surface of the container was performed. For the measurement and image analysis, MetroPro (Ver. 9.1.4 64-bit) was used as an application. An area of 282 μm×212 μm was measured, and wavelengths of 1.326 μm or less were removed from the obtained raw data to remove noise, and the result was used as measurement data. An average value was determined with N=5.

### (3) Slipperiness (Unit: N)

For the slipperiness of the obtained multilayered tray, using a friction tester (available from Toyo Seiki Seisaku-sho, Ltd.), a drag resistance value was determined by taking a load applied to a load cell during measurement as a dynamic friction force. In an environment at 23° C. and 50% RH, the multilayered tray was placed on an SUS plate, while a weight of 600 g was loaded, the measurement was performed at a rate of 100 mm/min. An average value was determined with N=5. Evaluation criteria are as follows:
∘: less than 2.5 N
Δ: 2.5 N or greater and less than 3.0 N
x: 3.0 N or greater

### (4) Drop Impact Resistance

In the obtained multilayered tray, 200 g of distilled water was placed, and a lid member was heat-sealed. Sterilization was performed by boiling at 95° C. for 30 minutes, and then the multilayered tray was stored at 5° C. for 24 hours. After the storage, the multilayered tray was dropped from a height of 150 cm in an environment at 5° C., and thus dropping resistance strength of the multilayered tray was determined. N was 20. Evaluation criteria are as follows.
◯: with 3 or less cracks
Δ: with less than 10 cracks
x: with 10 or more cracks

### (5) Flavor Barrier Properties

In the obtained multilayered tray, 200 g of distilled water was placed, and a lid member was heat-sealed. Sterilization was performed by boiling at 95° C. for 30 minutes, and then the multilayered tray was stored at room temperature for 24 hours. After the storage, sensory evaluation with 4-point scale was conducted by 10 experts, and an average value was determined. Evaluation criteria are as follows. 0 indicates no flavor was felt. 4 indicates a remarkable flavor was felt.
◯: less than 2.5
Δ: 2.5 or greater and less than 3.5
x: 3.5 or greater

Based on the obtained results, Experimental Examples 1 and 6 achieved excellent results as a result of having the polypropylene-based elastomer in the shape of spindle and providing the slipperiness and the drop impact resistance in a compatible manner. In particular, Experimental Example 6 also had the low resin viscosity and excellent film formability. Experimental Example 2 had somewhat low drop impact resistance, and it is conceived that this is an effect of the amount of the polypropylene-based elastomer being smaller. Experimental Examples 3 and 5 had somewhat low drop impact resistance, and it is conceived that this is an effect of the shape or particle size of the polypropylene-based elastomer. Furthermore, the result for the flavor barrier properties was inferior, and it is presumed that this is an effect of the molecular weight of the polypropylene-based elastomer. Experimental Example 4 had a poor result for the slipperiness although the drop impact resistance was good. It is conceivable that, because the polypropylene-based elastomer had a streak shape and the high aspect ratio, the surface protrusions and recesses became smooth and resulted in a large contact area.

TABLE 1

| | | | | Experimental | Experimental | Experimental | Experimental | Experimental | Experimental |
|---|---|---|---|---|---|---|---|---|---|
| | | | | Example 1 | Example 2 | Example 3 | Example 4 | Example 5 | Example 6 |
| Resin | MFR (g/10 min) | | | 0.4 | 0.5 | 0.5 | 0.6 | 0.4 | 0.5 (calculated |
| viscosity | | | | | | | | | value) |
| Structural | Blending | PP component | | 100 | 100 | 100 | 100 | 100 | 100 |
| analysis | ratio | (parts by mass) | | | | | | | |
| | | Rubber component | | 23.1 | 9.5 | 14.0 | 18.8 | 21.4 | 19.6 (calculated |
| | | (parts by mass) | | | | | | | value) |
| | Molecular | PP component | Mw | 394000 | 587000 | 503000 | 395000 | 406000 | — |
| | weight | | Mn | 112000 | 106000 | 116000 | 101000 | 112000 | — |
| | | Rubber component | Mw | 880000 | 749000 | 1310000 | 624000 | 1040000 | — |
| | | | Mn | 172000 | 28900 | 106000 | 89000 | 200000 | — |
| Measured | Domain | Domain size | | 0.57 | 0.82 | 0.63 | 0.48 | 1.17 | 0.56 |
| value | | corresponding | | | | | | | |
| | | to circle (μm) | | | | | | | |
| | | Aspect ratio | | 2.15 | 2.66 | 1.62 | 9.01 | 1.83 | 3.28 |
| | | Major axis (μm) | | 0.90 | 1.46 | 0.80 | 1.59 | 1.63 | 1.00 |
| | | Minor axis (μm) | | 0.38 | 0.53 | 0.51 | 0.18 | 0.91 | 0.34 |
| | Surface | Plane roughness: Sa (μm) | | 0.27 | 0.24 | 0.25 | 0.14 | — | 0.31 |
| | protrusions | | | | | | | | |
| | and recesses | | | | | | | | |

| | | | | | | | |
|---|---|---|---|---|---|---|---|
| Evaluation | Slipperiness (N) | ∘ (2.59) | ∘ (2.18) | ∘ (2.24) | x (3.24) | — | ∘ (2.18) |
| | Drop impact resistance | ∘ | Δ | Δ | ∘ | Δ | ∘ |
| | Flavor barrier properties | ∘ | ∘ | x | ∘ | Δ | ∘ |

### INDUSTRIAL APPLICABILITY

Because the packaging material and a layered body including a layer made of this packaging material as a surface layer of an embodiment of the disclosure have excellent drop impact resistance, blocking resistance, and flavor barrier properties, and also have excellent slipperiness, the packaging material and the layered body have excellent transportability in a production line. Thus, the packaging material and the layered body can be each suitably used for a packaging material for mass-produced food, especially for a container containing cooked rice or the like for which the flavor barrier properties are important. Furthermore, because the packaging material and the layered body are made of the propylene-based polymer having excellent heat resistance, the packaging material and the layered body can be also each suitably used as a packaging material, such as a pouch, that is subjected to retort sterilization or the like.

While preferred embodiments of the disclosure have been described above, it is to be understood that variations and modifications will be apparent to those skilled in the art without departing from the scope and spirit of the disclosure. The scope of the disclosure, therefore, is to be determined solely by the following claims.

1. A polypropylene-based packaging material comprising an ethylene-propylene block copolymer having a phase dispersion structure in which a resin containing a polypropylene as a main component is a matrix and a spindle-shaped polypropylene-based elastomer is a domain.

2. The polypropylene-based packaging material according to claim 1, wherein an aspect ratio of the domain is in a range of 1.2 to 9.0.

3. The polypropylene-based packaging material according to claim 1, wherein a minor axis of the domain is in a range of 0.2 to 4.0 μm, and a major axis is in a range of 0.5 to 5.0 μm.

4. The polypropylene-based packaging material according to claim 1, wherein the polypropylene-based packaging material contains from 1 to 30 parts by mass of the spindle-shaped polypropylene-based elastomer with respect to 100 parts by mass of the resin containing a polypropylene as a main component.

5. The polypropylene-based packaging material according to claim 1, wherein a weight average molecular weight (Mw) of the spindle-shaped polypropylene-based elastomer is from 500000 to 1000000, and a number average molecular weight (Mn) of the spindle-shaped polypropylene-based elastomer is from 10000 to 300000.

6. The polypropylene-based packaging material according to claim 1, wherein a weight average molecular weight (Mw) of the resin containing a polypropylene as a main component is from 300000 to 800000, and a number average molecular weight (Mn) of the resin containing a polypropylene as a main component is from 10000 to 300000.

7. The polypropylene-based packaging material according to claim 1, wherein from 1 to 30 parts by mass of a homopolypropylene is contained with respect to 100 parts by mass of the ethylene-propylene block copolymer.

8. The polypropylene-based packaging material according to claim 1, wherein a plane roughness (Sa) is from 0.15 to 1.0 μm.

9. The polypropylene-based packaging material according to claim 1, wherein the polypropylene-based packaging material has a form of a sheet, a film, a tray, or a cup.

10. A layered body comprising a polypropylene layer as a surface layer, the polypropylene layer containing an ethylene-propylene block copolymer that is the polypropylene-based packaging material according to claim 1,
a plane roughness (Sa) of the polypropylene layer being from 0.15 to 1.0 μm.

11. The layered body according to claim 10, at least comprising the polypropylene layers as inner and outer layers, and an oxygen-absorbing layer and a gas barrier layer as intermediate layers.

12. The layered body according to claim 10 having a form of a tray or a cup.

13. A method for manufacturing a layered body including, as a surface layer, a polypropylene layer containing an ethylene-propylene block copolymer,
the method comprising:
blending and melt-kneading a homopolypropylene as a viscosity modifier in the ethylene-propylene block copolymer to adjust a viscosity to a range where an MFR (230° C., 2.16 kg load) is from 0.1 to 10 g/10 min, and
forming a surface layer having a plane roughness of 0.15 μm to 1.0 μm by extruding the viscosity-adjusted molten resin.

14. The method for manufacturing a layered body according to claim 13, wherein from 1 to 30 parts by mass of the homopolypropylene is blended with respect to 100 parts by mass of the ethylene-propylene block copolymer.

15. The method for manufacturing a layered body according to claim 13, wherein the layered body contains from 1 to 30 parts by mass of the polypropylene-based elastomer with respect to 100 parts by mass of the ethylene-propylene block copolymer.

16. The method for manufacturing a layered body according to claim 13, wherein a weight average molecular weight (Mw) of the polypropylene-based elastomer is from 500000 to 1000000, and a number average molecular weight (Mn) of the polypropylene-based elastomer is from 10000 to 300000.

17. The method for manufacturing a layered body according to claim 13, wherein a weight average molecular weight (Mw) of the resin containing a polypropylene as a main component is from 300000 to 800000, and a number average molecular weight (Mn) of the resin containing a polypropylene as a main component is from 10000 to 300000.
